(19) United States
(12) Patent Application Publication
(10) Pub. No.: US 2004/0205608 A1
(43) Pub. Date: Oct. 14, 2004

(54) System and method for rearranging the layout of a business card

(76) Inventor: James Huang, Taipei (TW)

Correspondence Address: BIRCH STEWART KOLASCH & BIRCH, PO BOX 747, FALLS CHURCH, VA, 22040-0747, US

(21) Appl. No.: 10/005,811

(22) Filed: Dec. 7, 2001

(30) Foreign Application Priority Data
Sep. 12, 2001 (TW) 90122683

(51) Int. Cl. G06F 15/00

(52) U.S. Cl. 715/521

(57) ABSTRACT

A method for rearranging the layout of a business card, which obtains a boundary of a plurality of items selected by a user, and sorts the items along a first direction to obtain first-direction-sorted data. Once a no-text-content item is removed from the first-direction-sorted data, the positions of the remaining items are adjusted along the first direction, so that the items within the boundary are rearranged according to a request from the user.

### BACKGROUND OF THE INVENTION

1. Field of the Invention

The invention relates to a system and method for rearranging the layout of a business card, which rearranges the layout of the image file of the business card directly when the data on the business card are modified.

2. Related Art

According to the conventional procedures of producing business cards, one must first produce a card sample and send or mail the card sample to a printing house. The printing house then makes a plate of the card sample to print business cards. When the data on the business card are to be changed, one must produce another card sample, and send it to the printing house again. The printing house then make another plate of the new card sample. When the document flow procedures in a company are taken into consideration as well, it is apparent that the overall procedures of printing business cards are complex, inconvenient and time-consuming.

Due to the development of computer and network technologies, it is usual to print business cards with the aid of computers and networks. Referring to FIG. 6, in the traditional procedure for printing business cards with the aid of computer and network technologies, a card-processing company first receives a card sample sent from a customer in step 101. The card sample may be an image file sent via a network or an actual business card sample sent via mail. Then, in the step 102, the card-processing company generates a “template”. The template is a web page representing the layout design of a business card, and is generated by an employee of the card-processing company using web page editing software. The customer can browse the template via a network using an internet browser to preview the layout design of the business card.

Since the template is a web page, as long as the design of the business card is not changed, the card-processing company can edit the data on the template using the web page editing software directly without producing another template. Therefore, in step 103, the card-processing company edits data on the template directly to modify the name, extension number or email address on the business card.

The card-processing company can also store the data of the template in a database, and link the template to the database. Then, the card-processing company can provide active server pages for the customer to edit the data of the template stored in the database via the network.

Since the customer can browse the template to see whether or not the data are correct, the card-processing company can add a “confirm” button on the active server pages or the template. If the data are correct, the customer can click the button directly to send a confirmation message to the card-processing company via the network.

After receiving the confirmation message, the card-processing company transforms the template to an image file manually using image processing software, and sends this image file to the printing house to print business cards in step 104.

One disadvantage of the above-mentioned procedures is that since the template is a web page, it is inconvenient for the card-processing company to rearrange the layout of the business card when the customer deletes some data from the template. For example, FIG. 7A shows an original template 21, and FIG. 7B shows a revised template 21′ with the fax number being deleted. As shown in FIG. 7B, after the customer deletes the fax number from the template, a blank area will be fromed on the business card. To eliminate the unwanted blank area, the employee of the card-processing company must rearrange the layout of the business card. However, since the template is a web page in HTML format, the employee of the card-processing company must rearrange the layout of the template by modifying the HTML content of the template. That is, the employee must adjust the positions of the text lines, heights of the text lines and/or the margins between text lines manually, which is inconvenient and time-consuming.

### SUMMARY OF THE INVENTION

In view of above, an objective of the invention is to provide a system and method for rearranging the layout of a business card, which facilitates the process of rearranging the layout design of the business card.

Another objective of the invention is to provide a system and method for rearranging the layout of a business card, which can reduce the cost required in processing the business card.

Still another objective of the invention is to provide a system and method for rearranging the layout of a business card, which can enhance the efficiency of rearranging the layout of the business card.

To achieve the above objectives, the method for rearranging the layout of a business card according to the invention is to set a boundary for a plurality of items selected by a user, and sorts the items along a first direction to obtain first-direction-sorted data. Once a no-text-content item is removed from the first-direction-sorted data, the positions of the remaining items are adjusted along the first direction, so that the items within the boundary are rearranged according to a request from the user.

According to one aspect of the invention, the items might be sorted along a second direction, which is not parallel to the first direction mentioned above, to obtain second-direction-sorted data. Once a no-text-content item is removed, the remaining items are also adjusted along the second direction.

According to another aspect of the invention, obtaining, sorting, removing and adjusting the data are accomplished by a macro language program modules in an image processing software.

According to still another aspect of the invention, the first-direction-sorted data and the second-direction-sorted data are stored in a 2D array.

Furthermore, the invention provides a system for rearranging the layout of the business card, which includes a boundary obtaining module, a first sorting module and a first adjusting module. The boundary obtaining module obtains a boundary for a plurality of items selected by a user. The first sorting module sorts the items along a first direction to obtain a first-direction-sorted data. The first adjusting module removes a no-text-content item from the first-direction-sorted data and adjusts the positions of the remaining items along the first direction to rearrange the items within the boundary according to a request of the user. The boundary obtaining module, the first sorting module and the first adjusting module may be macro language program modules in an image processing software.

Since the system and method according to the invention allows the employee of the card-processing company to rearrange the layout of the business card file using an image processing software directly, the employee does not have to produce different templates for business cards of different layout arrangements. Therefore, the cost of business card processing can be significantly reduced. Furthermore, the efficiency of rearranging the layout of the business card can be greatly increased.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a block diagram showing the business card processing system according to a preferred embodiment of the invention;

FIG. 2 is a block diagram showing the modules in the layout designing software according to the preferred embodiment of the invention;

FIG. 3 is a schematic diagram showing the process that the data of the items of a business card are stored in an array;

FIG. 4 is a schematic diagram showing the process in which the data of the items are stored in an array according to a specific example of the invention;

FIG. 5 is a schematic diagram showing the process in which an item is removed from the array according to a specific example of the invention.

FIG. 6 is a flowchart showing the procedure for printing a business card in prior art; and

FIGS. 7A and 7B are schematic diagrams showing the templates of a business card in the prior art.

### DETAILED DESCRIPTION OF THE PREFERRED EMBODIMENT

A preferred embodiment of the invention will be described with reference to the accompanying drawings, wherein the same reference numerals refer to the same elements.

The system 1 for rearranging the layout of a business card according to a preferred embodiment of the invention is a computer system with ordinary architecture, for example, a computer system including a CPU, data storage devices such as DRAM and hard disk drive, input devices such as a keyboard and a mouse, and output device such as a CRT or LCD display.

Referring to FIG. 1, the system 1 includes a receiving module 11, a database 12, an interactive web page 13 and layout designing software 14. The receiving module 11 may be any kind of network interface module providing services at the data link level of the network, and is able to receive a business card file 21 sent from a customer via a network.

In the preferred embodiment, the business card file 21 is an image file or a data file generated by CorelDraw or any other image processing software. For example, if the customer uses CorelDraw, the business card file 21 is a *.cdr file, which is a data file of an image, or a *.crf file, which is a text file containing information of the image.

The database 12 may be any kind of conventional electronic database, which stores the business card file 21 and its corresponding data in a storage device. For example, in the preferred embodiment, the database stores the text contents of the items on a business card, such as name, address and telephone number in a storage device. Furthermore, the database 12 stores the business card file 21 containing layout information of the business card, such as the position and the boundary of each item.

The interactive web page 13 is generated with reference to the database 12, and provides a plurality of text areas for a customer to browse and modify the text contents of the items stored in the database 12 via a network. To modify the text contents of the items stored in the database 12, the customer can enter new data in the text areas directly, and clicking on the “Confirm” button on the interactive web page 13.

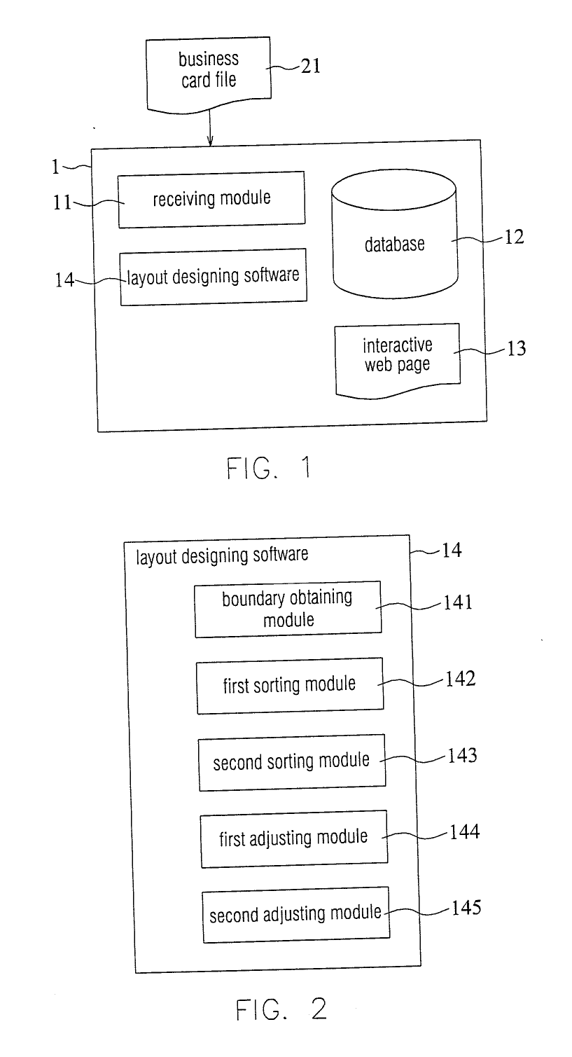

Referring to FIG. 2, the layout designing software 14 includes a boundary obtaining module 141, a first sorting module 142, a second sorting module 143, a first adjusting module 144 and a second adjusting module 145. In the preferred embodiment, the layout designing software 14 is a conventional image processing software, which can process the business card file 21 directly. The modules can be macro language program modules such as VBA (Visual Basic for Application) macro commands provided in the image processing software.

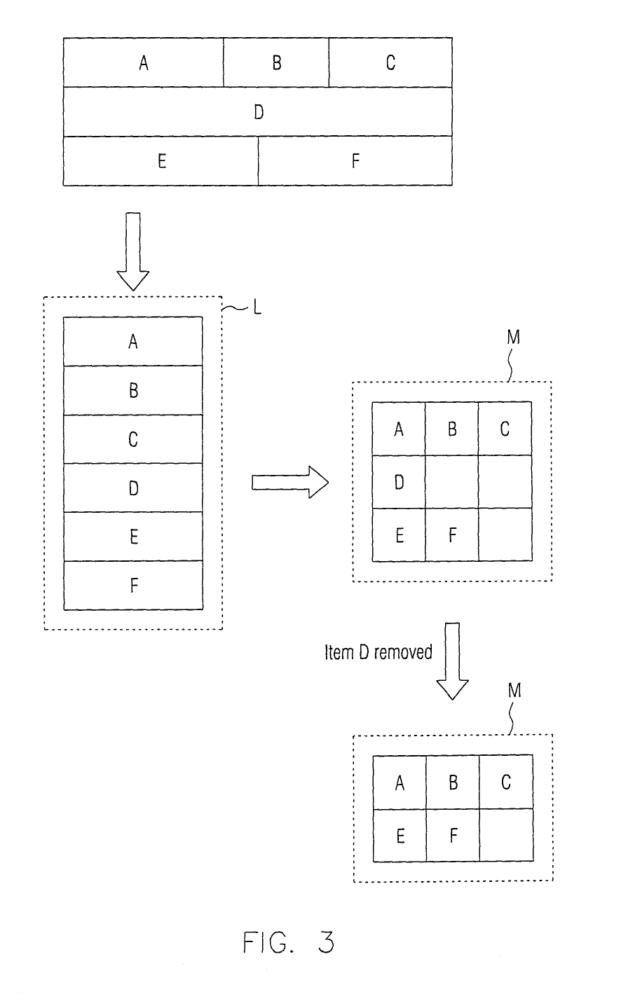

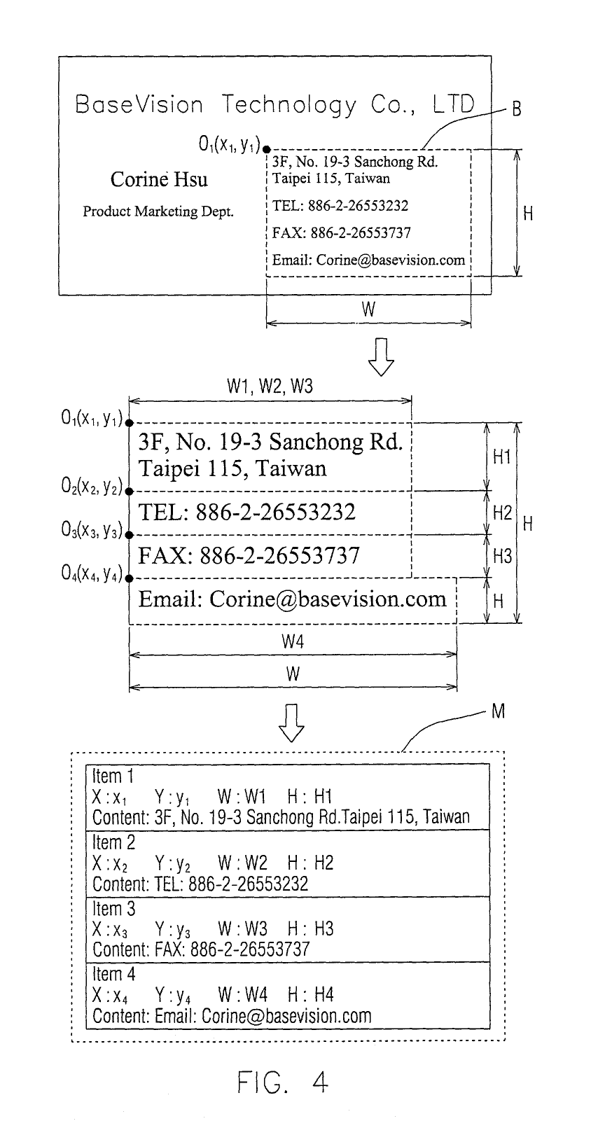

Referring to FIG. 3, if the selected items include item A, B, C, D, E and F, the boundary obtaining module 141 obtains a boundary for a plurality of items selected by a user. In the preferred embodiment, the boundary is the rectangle that surrounds all items selected by the user denoted by dotted lines in FIG. 4.

Then, the identification codes, coordinates, heights and widths of the items are stored in a linked list L. The first sorting module 142 and the second sorting module 143 sort the data stored in the linked list along a first direction and a second direction respectively using any sorting algorithm, and store the sorting results in a 2D array M.

Once the user deletes the text content of an item, the no-text-content item is removed from the array M. Then, the first adjusting module 144 and the second adjusting module 145 adjust the positions of the remaining items along the first direction and the second direction respectively according to a request from the user. The request may be arbitrary kind of layout arranging request, such as ‘align to the top’, ‘align to the bottom’ or ‘spread evenly’, etc.

To help the persons skilled in the art understand the content of the invention, a specific and illustrative example will be given hereinafter to further illustrate the layout rearranging procedure according to the preferred embodiment of the invention.

Referring to FIG. 4, when a user selects the items related to the address, the telephone number, the fax number and the email on the business card, the boundary obtaining module 141 obtains the coordinates of the top-left points O1, O2, O3 and O4, the widths W1, W2, W3 and W4 and the heights H1, H2, H3 and H4 of the rectangles enclosing the items.

The boundary B of the items is shown as a dotted line rectangle in FIG. 4. The top-left point of the boundary B is point O1, which is the most top-left point among points O1, O2, O3 and O4. The height H of the boundary B is the sum of the heights H1, H2, H3 and H4, and the width W of the boundary B is the sum of the widths W1, W2, W3 and W4.

The coordinates, widths and heights of the rectangles enclosing the items and the text contents of the items are stored in a linked list. The first sorting module 142 sorts the linked list by any sorting algorithm, for example, the bubble-sorting algorithm according to the coordinates of the items. The sorting result is stored in an array M.

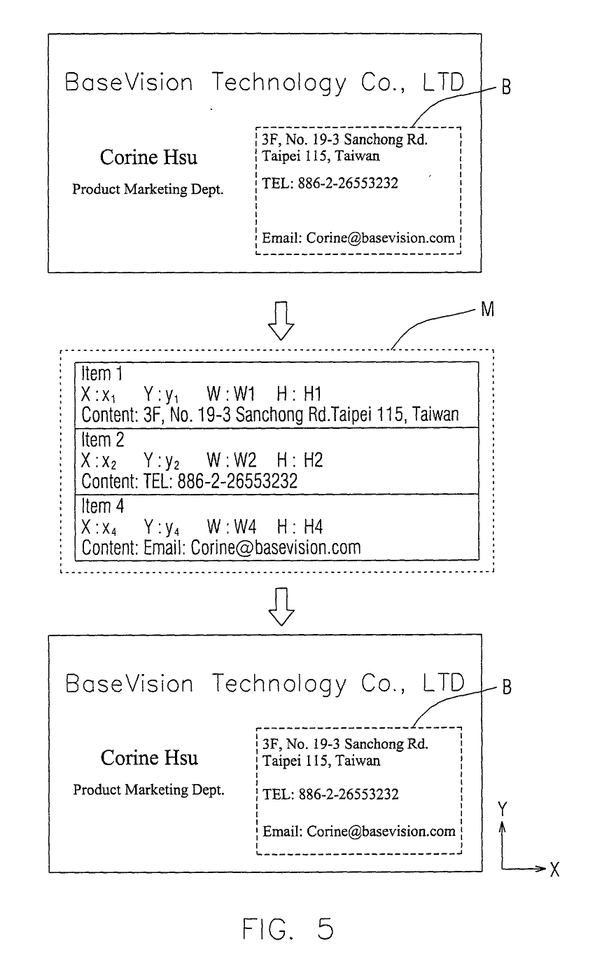

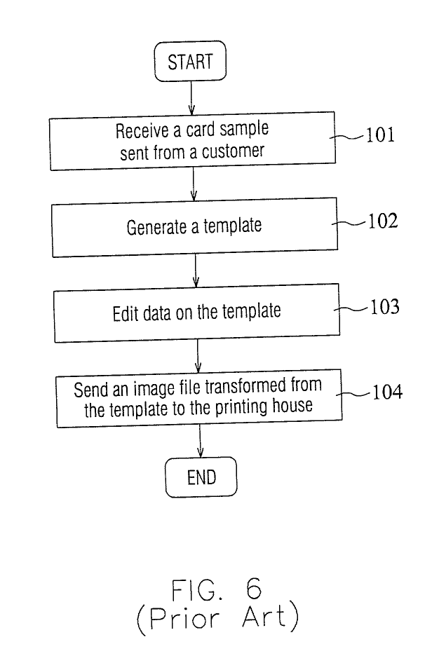

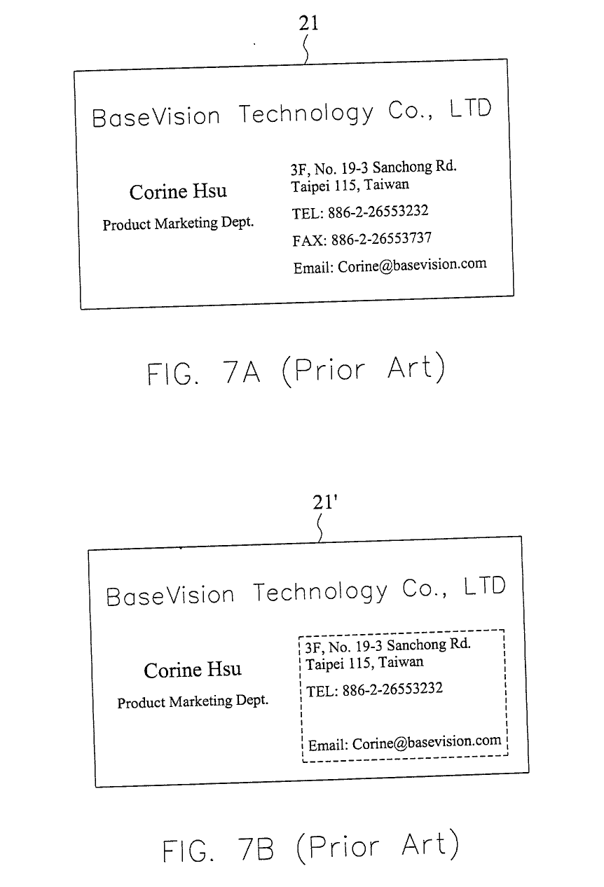

Referring to FIG. 5, when the fax number is deleted from the business card, the first adjusting module 144 removes the no-text-content item, i.e., the fax number from the array M, and adjusts the positions of the remaining items along the first direction according to a request from the user. In the example, as shown in FIG. 5, the items are evenly spread within the boundary B along the Y direction. However, the user might input other requests, such as align to the top, or align to the bottom of the boundary B to obtain different layout arrangements.

According to the system and method of the invention, the employee of a card processing company can rearrange the layout of the business card efficiently. Therefore, the efficiency of rearranging the layout of the business card can be greatly enhanced.

Furthermore, the system and method according to the invention allows the employee of a card-processing company to rearrange the layout of a business card file using an image processing software directly. The employee does not have to produce another templates for business cards of different layout arrangements. Therefore, the cost of business card processing can be significantly reduced.

While the invention has been described with reference to a preferred embodiment, this description is not intended to be construed in a limiting sense. Various modifications of the embodiment will be apparent to persons skilled in the art upon reference to the description. Therefore, it is intended that the appended claims encompass any such modifications.

What is claimed is:

1. A system for rearranging the layout of a business card, comprising:
a boundary obtaining module for obtaining a boundary for a plurality of items selected by a user;
a first sorting module for sorting the items along a first direction to obtain a first-direction-sorted data; and
a first adjusting module for removing a no-text-content item from the first-direction-sorted data and adjusting the positions of the remaining items along the first direction to rearrange the items within the boundary according to a request from the user.

2. The system according to claim 1, wherein the boundary obtaining module, the first sorting module and the first adjusting module are macro language program modules in an image processing software.

3. The system according to claim 1, wherein the first-direction-sorted data are stored in an array.

4. The system according to claim 1, further comprising:
a second sorting module for sorting the items along a second direction not parallel to the first direction to obtain second-direction-sorted data; and
a second adjusting module for removing the no-text-content item from the second-direction-sorted data and adjusting the positions of the remaining items along the second direction.

5. The system according to claim 4, wherein the second sorting module and the second adjusting module are macro language program modules in an image processing software.

6. The system according to claim 4, wherein the second direction is perpendicular to the first direction.

7. The system according to claim 4, wherein the first-direction-sorted data and the second-direction-sorted data are stored in a 2D array.

8. The system according to claim 1, wherein the request is evenly spreading the items within the boundary.

9. The system according to claim 1, wherein the request is aligning the items to the top of the boundary.

10. A method for rearranging the layout of a business card, comprising:
obtaining a boundary of a plurality of items selected by a user;
sorting the items along a first direction to obtain first-direction-sorted data;
removing a no-text-content item from the first-direction-sorted data; and
adjusting the positions of the remaining items along the first direction to rearrange the items within the boundary according to a request from the user.

11. The method according to claim 10, wherein the obtaining, sorting, removing and adjusting are accomplished by macro language program modules in an image processing software.

12. The method according to claim 10, wherein the first-direction-sorted data are stored in an array.

13. The method according to claim 10, further comprising:
sorting the items along a second direction not parallel to the first direction to obtain second-direction-sorted data; and
removing the no-text-content item from the second-direction-sorted data and adjusting the positions of the remaining items along the second direction.

14. The method according to claim 13, wherein the sorting of the items along of the second direction and the removing of the no-text-content item from the second-direction-sorted data are accomplished by macro language program modules in an image processing software.

15. The method according to claim 13, wherein the second direction is perpendicular to the first direction.

16. The method according to claim 13, wherein the first-direction-sorted data and the second-direction-sorted data are stored in a 2D array.

17. The method according to claim 10, wherein the request is evenly spreading the items within the boundary.

18. The method according to claim 10, wherein the request is aligning the items to the top of the boundary.

19. A computer-readable storage medium having instructions recorded thereon to direct a computer to execute a method for rearranging the layout of a business card, the method comprising:
obtaining a boundary of the data selected by a user, the data comprising a plurality of items;
sorting the items along a first direction to obtain first-direction-sorted data;
removing a no-text-content item from the first-direction-sorted data; and
adjusting the positions of the remaining items along the first direction to rearrange the items within the boundary according to a request from the user.

20. The computer-readable storage medium according to claim 19, wherein the instructions recorded on the storage medium are macro language program modules in an image processing software.

21. The computer-readable storage medium according to claim 19, wherein the first-direction-sorted data are stored in an array.

22. The computer-readable storage medium according to claim 19, wherein the method further comprises:
sorting the items along a second direction not parallel to the first direction to obtain second-direction-sorted data; and
removing the no-text-content item from the second-direction-sorted data and adjusting the positions of the remaining items along the second direction.

23. The computer-readable storage medium according to claim 22, wherein the sorting of the items along the second direction and the removing of the no-text-content item from the second-direction-sorted data are accomplished by macro language program modules in an image processing software.

24. The computer-readable storage medium according to claim 22, wherein the second direction is perpendicular to the first direction.

25. The computer-readable storage medium according to claim 22, wherein the first-direction-sorted data and the second-direction-sorted data are stored in a 2D array.

26. The computer-readable storage medium according to claim 19, wherein the request is evenly spreading the items within the boundary.

27. The computer-readable storage medium according to claim 19, wherein the request is aligning the items to the top of the boundary.
